(19) United States
(12) Patent Application Publication
(10) Pub. No.: US 2023/0330733 A1
(43) Pub. Date: Oct. 19, 2023

(54) DIE AND PRESS-MOLDING APPARATUS

(71) Applicant: NIPPON STEEL CORPORATION, Chiyoda-ku, Tokyo (JP)

(72) Inventors: Ryo URUSHIBATA, Chiyoda-ku, Tokyo (JP); Yasuhiro ITO, Chiyoda-ku, Tokyo (JP); Masahiro NAKATA, Chiyoda-ku, Tokyo (JP)

(21) Appl. No.: 18/028,762

(22) PCT Filed: Oct. 6, 2021
(86) PCT No.: PCT/JP2021/037023

§ 371 Date: Mar. 28, 2023

(30) Foreign Application Priority Data
Oct. 6, 2020 (JP) 2020-169395

(51) Int. Cl. B21D 5/02

(52) U.S. Cl. CPC B21D 5/0209

(57) ABSTRACT

A die includes a first die and a second die, and at least one of the first die or the second die includes: a bottom portion having a plate shape; a top portion having a plate shape and is provided apart from the bottom portion; and a stiffening member having one end directly connected to the bottom portion and another end connected to the top portion, the stiffening member extending in an inclined manner from a connection portion with the bottom portion toward a side at which a center of the top portion is located as the stiffening member extends from the bottom portion side toward the top portion side.

### TECHNICAL FIELD

The present disclosure relates to a die and a press-molding apparatus.

### BACKGROUND ART

Conventionally, it has been known that, when press molding is performed on a workpiece such as a steel plate using a die, the die bends as described in Japanese Patent No. 4955923. For example, when a bed of a pressing machine has a cavity for housing a cushion pad or the like therein, a lower die of the die is placed on the cavity of the bed via a bolster. In addition, an upper die corresponding to the lower die is disposed on the lower die.

At the time of press molding, when a slide disposed on the upper side of the bolster is lowered and presses the die, elastic deformation occurs in the bolster and the lower die at the molding bottom dead center due to the presence of the cavity. In addition, a bowl-shaped deflection in which the center protrudes downward is temporarily formed at a top portion which is a region on a workpiece side of the lower die.

As another example of a press machine using a die, Japanese Patent Application Laid-Open (JP-A) No. H07-323400 discloses a press die including a lower frame on which a panel as a lower die is disposed and an upper frame on which a panel as an upper die is disposed. An oblique rib extending from a lower portion toward an upper portion is provided inside the lower die of JP-A No. H07-323400.

In addition, Japanese Patent Application Laid-Open (JP-A) No. S61-266147 discloses a pressing die including a lower die and an upper die. The lower die of JP-A No. S61-266147 is provided with a bottom plate portion, a pair of side plate portions vertically rising from the bottom plate portion, and a pair of upper plate portions connected to the pair of side plate portions. Each of the pair of upper plate portions extends in an inclined manner so as to be close to each other from the side plate portions toward the upper side. The pair of upper plate portions is connected to a forming portion as an upper portion of the lower die.

Further, Japanese Patent No. 5458341 discloses a lower die of a press molding die including a frame-shaped base formed of a bar-shaped member in a rectangular shape in plan view, and a bar-shaped member that is lowered vertically from each of four corners of the base. The lower die of Japanese Patent No. 5458341 includes an upper rod-shaped member corresponding to one side of a rectangular frame, a lower rod-shaped member disposed in parallel with the upper rod-shaped member with a space therebetween under the upper rod-shaped member, and a rod-shaped reinforcing member obliquely connecting the upper rod-shaped member and the lower rod-shaped member.

Patent Literature 1: Japanese Patent No. 4955923

Patent Literature 2: Japanese Patent Application Laid-Open (JP-A) No. H07-323400

Patent Literature 3: Japanese Patent Application Laid-Open (JP-A) No. S61-266147

Patent Literature 4: Japanese Patent No. 5458341

### SUMMARY OF INVENTION

### Technical Problem

Here, during the press molding, a die face for forming is formed by the upper surface of the top portion of the lower die or the upper surface of the insert placed on the top portion. Thus, deflection of the top portion of the lower die leads to deflection of the die face. As a result, there arises a problem of ease of molding in press molding and quality of a press-molded product as a product, or a problem of difficulty in developing a die. The deflection of the die causing such a problem can be formed not only at the top portion of the lower die but also at the top portion which is a region on the workpiece side of the upper die.

As a technique for solving the problem caused by the deflection of the die, Japanese Patent No. 4955923 discloses a technique for improving the structure of a bolster of a pressing machine. In Japanese Patent No. 4955923, a support portion in which vertical flat plate-shaped members are combined in a cross shape is provided upright on a floor portion of an internal space of a bed. The support portion supports the center of the lower surface of the bolster from the lower side, whereby the deflection of the bolster is suppressed, and highly accurate press molding can be realized.

However, since the bolster and the bed constituting the pressing machine are members having relatively large dimensions, there is a problem that the improvement work becomes large and the improvement cost of the entire press-molding apparatus increases. In addition, when the existing press-molding apparatus is improved, there is also a concern that the time for stopping the press line for the improvement work becomes long. That is, when the configuration on the pressing machine side is improved using the technology of Japanese Patent No. 4955923, there is a problem that the burden of improvement work is large.

In the case of the press die disclosed in JP-A No. H07-323400, the oblique rib extends from the central side toward the outer end portion of the lower frame in side view. For this reason, in the case of the press die of JP-A No. H07-323400, it is not possible to efficiently support the central side on which large deflection occurs in the upper portion of the lower die which is the workpiece side. Further, in the case of the press die of JP-A No. H07-323400, since the lower portion of the lower frame is not in contact with the floor surface, it is difficult to transmit the load during the press molding between the oblique rib connected to the lower portion of the lower frame and the floor surface. That is, in Japanese Patent Application Laid-Open No. H7-323400, suppressing the deflection of the die is not sufficiently considered.

Further, in the case of the pressing die disclosed in JP-A No. S61-266147, since the upper plate portion disposed inside the lower die extends in an inclined manner toward the upper side, it is conceivable that the central side of the forming portion forming the upper portion of the lower die is supported by the upper plate portion to some extent. However, in the case of the pressing die of JP-A No. S61-266147, the upper plate portion is not directly connected to the bottom plate portion on the grounding portion side, but is indirectly connected to the bottom plate portion via the side plate portion as a vertical straight portion. That is, when the load during the press molding is transmitted from the bottom plate portion to the upper plate portion in the lower die, the load needs to pass through the vertical side plate portion prior to the upper plate portion. Therefore, it is difficult to efficiently guide the load during the press molding between the upper plate portion and the forming portion.

In the case of the lower die of the press molding die disclosed in Japanese Patent No. 5458341, the upper structure of the lower die is not a plate shape but a frame shape. In addition, the reinforcing member extends in an inclined manner in a vertical plane formed between the upper bar-shaped member and the lower bar-shaped member at one side of the rectangular frame shape, that is, at the position of the end portion. For this reason, only one side portion of the end portion in the upper portion of the lower die is supported by the reinforcing member, and it is not possible to efficiently support the central side of the upper portion, which is the workpiece side, where large deflection occurs during press molding. That is, in Japanese Patent No. 5458341, suppressing the deflection of the die is not sufficiently considered.

In view of the above problems, an object of the disclosure is to provide a die and a press-molding apparatus capable of suppressing deflection of the die on a workpiece side by directly improving the die itself relatively easily without the need to improve a configuration on a pressing machine side.

### Solution to Problem

A die according to a first aspect of the disclosure is a die including a first die and a second die, in which at least one of the first die or the second die includes: a bottom portion having a plate shape; a top portion that has a plate shape and is provided apart from the bottom portion; and a stiffening member having one end directly connected to the bottom portion and another end connected to the top portion, the stiffening member extending in an inclined manner from a connection portion with the bottom portion toward a side at which a center of the top portion is located as the stiffening member extends from the bottom portion side toward the top portion side.

A press-molding apparatus according to a second aspect of the disclosure includes: a support device; a slide that is lowered during press molding; and a die according to the first aspect, which is disposed between the support device and the slide.

### Advantageous Effects of Invention

According to the disclosure, it is possible to provide the die and the press-molding apparatus capable of suppressing deflection of the die on the workpiece side by directly improving the die itself relatively easily without the need to improve the configuration on the pressing machine side.

### BRIEF DESCRIPTION OF DRAWINGS

FIG. 1 is a partially cutaway front view illustrating a configuration of a press-molding apparatus according to a first embodiment.

FIG. 2 is a partially cutaway front view illustrating a state in which a press machine and a die included in the press-molding apparatus according to the first embodiment bend.

FIG. 3 is a partially cutaway enlarged front view illustrating a state in which a lower die according to the first embodiment bends.

FIG. 4 is a partially cutaway front view illustrating a state in which a press machine and a die included in a press-molding apparatus according to a comparative example bend.

FIG. 5 is a partially cutaway enlarged front view illustrating a state in which a lower die according to the comparative example bends.

FIG. 6 is a perspective view illustrating a structure of a die model of a lower die for analysis corresponding to the lower die according to the first embodiment.

FIG. 7 is a graph showing a deflection amount of the lower die according to an example of the first embodiment and a deflection amount of the lower die according to the comparative example, which are calculated using the die model for analysis.

FIG. 8A is a front view illustrating a configuration in a case in which a stiffening member is provided only on one side in the left-right direction in a lower die according to a modification of the first embodiment.

FIG. 8B is a front view illustrating a configuration in a case in which two pairs of stiffening members are provided on the left and right in a lower die according to a modification of the first embodiment.

FIG. 8C is a partially cutaway front view illustrating a configuration in a case in which a deepest portion of deflection of a bolster and a center of a top portion of a lower die are displaced from each other during press molding in a lower die according to a modification of the first embodiment.

FIG. 9A is a front view illustrating a configuration in a case in which stiffening members not connected to longitudinal ribs are provided in a lower die according to a modification of the first embodiment.

FIG. 9B is a front view illustrating a configuration in a case in which upper portions of stiffening members are connected to a region of a center height of a longitudinal rib in a lower die according to a modification of the first embodiment.

FIG. 9C is a front view illustrating a configuration in a case in which two stiffening members support one longitudinal rib from both sides in a lower die according to a modification of the first embodiment.

FIG. 9D is a front view illustrating a configuration in a case in which upper portions of two stiffening members are connected at a center inside a lower die and one longitudinal rib extends upward from a connection portion of the two stiffening members in the lower die according to a modification of the first embodiment.

FIG. 10A is a front view illustrating a configuration in a case in which no longitudinal rib is provided in a lower die according to a modification of the first embodiment.

FIG. 10B is a front view illustrating another configuration in a case in which no longitudinal rib is provided in a lower die according to a modification of the first embodiment.

FIG. 10C is a front view illustrating a configuration in a case in which the stiffening members also serve as side walls of a lower die in the lower die according to a modification of the first embodiment.

FIG. 10D is a front view illustrating a configuration in a case in which longitudinal ribs are provided in the lower die in FIG. 10C.

FIG. 11A is a perspective view illustrating a configuration in a case in which four stiffening members are provided in a lower die according to a modification of the first embodiment.

FIG. 11B is a perspective view illustrating a configuration in a case in which eight stiffening members are provided in a lower die according to a modification of the first embodiment.

FIG. 12A is a perspective view illustrating a configuration in a case in which one side of a rectangular stiffening member intersects an X direction and a Y direction in a lower die according to a modification of the first embodiment.

FIG. 12B is a perspective view illustrating a configuration in a case in which an upper portion of a triangular stiffening member is connected to a region of an upper end of a longitudinal rib in a lower die according to a modification of the first embodiment.

FIG. 12C is a perspective view illustrating a configuration in a case in which an upper portion of a triangular stiffening member is connected to a region of a center height of a longitudinal rib in a lower die according to a modification of the first embodiment.

FIG. 13A is a perspective view illustrating a configuration in a case in which a trapezoidal stiffening member is provided in a lower die according to a modification of the first embodiment.

FIG. 13B is a perspective view illustrating a configuration in a case of another example in which a trapezoidal stiffening member is provided in a lower die according to a modification of the first embodiment.

FIG. 13C is a perspective view illustrating a configuration in a case of still another example in which a trapezoidal stiffening member is provided in a lower die according to a modification of the first embodiment.

FIG. 14A is a perspective view illustrating a configuration of a rectangular stiffening member in which a hollow portion as an example of a lightening process is formed in a lower die according to a modification of the first embodiment.

FIG. 14B is a perspective view illustrating a configuration of a triangular stiffening member in which a hollow portion as an example of a lightening process is formed in a lower die according to a modification of the first embodiment.

FIG. 14C is a perspective view illustrating a configuration of a stiffening member that has been narrowed as an example of a lightening process in a lower die according to a modification of the first embodiment.

FIG. 14D is a perspective view illustrating a configuration of another example of a stiffening member that has been narrowed as an example of a lightening process in a lower die according to a modification of the first embodiment.

FIG. 15A is a perspective view illustrating a configuration of one rod-shaped stiffening member that has been narrowed as an example of a lightening process in a lower die according to a modification of the first embodiment.

FIG. 15B is a perspective view illustrating a configuration of another example of one rod-shaped stiffening member that has been narrowed as an example of a lightening process in a lower die according to a modification of the first embodiment.

FIG. 15C is a perspective view illustrating a configuration of two rod-shaped stiffening members that have been narrowed as an example of a lightening process in a lower die according to a modification of the first embodiment.

FIG. 15D is a perspective view illustrating a configuration of another example of two rod-shaped stiffening members that have been narrowed as an example of a lightening process in a lower die according to a modification of the first embodiment.

FIG. 16 is a cross-sectional view illustrating a configuration of a lower die according to a modification of the first embodiment.

FIG. 17 is a partially cutaway front view illustrating a configuration of a press-molding apparatus according to a second embodiment.

FIG. 18 is a partially cutaway front view illustrating a configuration of a press-molding apparatus according to a third embodiment.

FIG. 19A is a front view illustrating a configuration of a press-molding apparatus in a state where a first die and a second die of a die are separated from each other in a case in which the first die and the second die are disposed to face each other in the horizontal direction.

FIG. 19B is a front view illustrating a configuration of the press-molding apparatus in a state where the first die and the second die of the die are close to each other, following FIG. 19A.

### DESCRIPTION OF EMBODIMENTS

Hereinafter, first to third embodiments of the disclosure will be described. In the following description of the drawings, the same reference numerals or similar reference numerals are assigned to the same portions and similar portions. However, the relationship between the thickness and the plane dimension in the drawings, the ratio of the thickness of each device and each member, and the like are different from the actual ones. Therefore, specific thicknesses and dimensions should be determined in consideration of the following description. In addition, the drawings include portions having different dimensional relationships and ratios.

### First Embodiment

### Structure of Press-Molding Apparatus

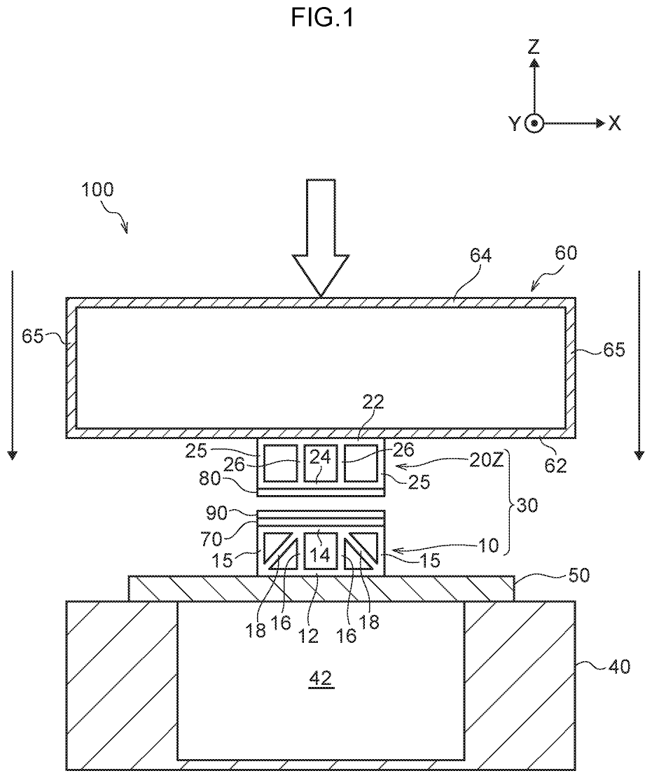

First, a press-molding apparatus 100 according to a first embodiment will be described with reference to FIGS. 1 to 16. As illustrated in FIG. 1, the press-molding apparatus 100 according to the first embodiment includes a bed 40, a bolster 50, a die 30, and a slide 60. In the first embodiment, the bed 40, the bolster 50, and the slide 60 are a press machine.

A cavity 42 that opens upward is provided inside the center of the bed 40. For example, a die cushion pad (not illustrated) is housed in the cavity 42. The bolster 50 is placed on the cavity 42 of the bed 40. The bed 40 of the present embodiment corresponds to a “support device” of the disclosure, and supports the die 30 disposed between the bed 40 and the slide 60.

The slide 60 is provided on the upper side of the die 30. The slide 60 has a box shape and includes a bottom portion 62, a top portion 64, and a side wall 65. A cavity is formed inside the slide 60. In the disclosure, the structure of the slide 60 is not limited to that illustrated in FIG. 1, and can be changed as appropriate. A drive device (not illustrated) is connected to the slide 60, and the slide 60 can be raised and lowered by the drive device. The slide 60 is lowered toward the die 30 during press molding to apply a load to the die 30.

The cavity 42 of the bed 40 and the cavity of the slide 60 are each a “cavity” of the disclosure. That is, the “cavity” may be partially open, or may be closed by surrounding the entire periphery. Furthermore, for example, one or more partition walls may be provided inside the slide 60, and a cavity may be formed between the partition walls or between the partition wall and the side wall.

### Die

As illustrated in FIG. 1, the die 30 is disposed on the bolster 50 so as to overlap the cavity 42 of the bed 40. The die 30 includes a lower die 10 and an upper die 20Z. The lower die 10 of the present embodiment corresponds to a “first die” of the disclosure, and the upper die 20Z of the present embodiment corresponds to a “second die” of the disclosure.

In the first embodiment, the overall shape of the lower die 10 and the overall shape of the upper die 20Z are each a rectangular parallelepiped shape. In the disclosure, the overall shape of the lower die 10 and the overall shape of the upper die 20Z are not limited to a rectangular parallelepiped shape, and may be any other geometric shape. The overall shape of the lower die 10 and the overall shape of the upper die 20Z may be different from each other. In addition, in order to assist fitting between the lower die 10 and the upper die 20Z during press molding, for example, a guide portion to be fitted in correspondence with each other such as a convex portion and a concave portion may be additionally provided.

As the material of the lower die 10 and the material of the upper die 20Z constituting the die 30, for example, steel materials of FCD 600-3 (600-3 in ISO) of ductile cast iron in JIS and FC 250 (185/JL/250 in ISO) of gray iron in JIS can be adopted. In addition, a steel material of SS 400 (E 275 A, E 275 B, E 275 C, E 275 D, R 630, Fe 42 A, 44 A in ISO) of a ferrous material for general structure in JIS can be adopted. In addition, a carbon steel material S 45 C (C 45 in ISO) for machine structure in JIS, and a steel material SKD 11 (X210Cr12W12 in ISO) of alloy tool steel in JIS can be adopted. However, in the disclosure, the material of the lower die and the material of the upper die constituting the die are not limited to the steel material, and can be appropriately changed.

On the upper surface of the lower die 10, a lower insert 70 forming a die face is disposed. On the lower surface of the upper die 20Z, an upper insert 80 is disposed to form a pair with the lower insert 70. A workpiece 90 such as a steel plate is sandwiched between the lower insert 70 and the upper insert 80. The workpiece is not limited to a steel plate, and various other metal materials may be adopted, and a workpiece side other than the metal material may be adopted.

### Upper Die

The upper die 20Z includes a bottom portion 22, a top portion 24, side walls 25, and longitudinal ribs 26. The bottom portion 22 and the top portion 24 are connected to each other by the side walls 25 and the longitudinal ribs 26. The bottom portion 22 has a plate shape and is provided on the slide 60 side (upper side in FIG. 1). The top portion 24 has a plate shape and is provided on the bolster 50 side (lower side in FIG. 1) away from the bottom portion 22, and the workpiece 90 is located on the lower side of the top portion 24 in FIG. 1. The side walls 25 have a plate shape, are provided at both ends in the X direction (left-right direction in FIG. 1) of the upper die 20Z, and extend vertically along the Z direction (up-down direction in FIG. 1). The Z direction is a movable direction of the slide 60. Upper ends of the side walls 25 and upper ends of the longitudinal ribs 26 are connected to a lower surface of the bottom portion 22 in FIG. 1. Lower ends of the side walls 25 and lower ends of the longitudinal ribs 26 are connected to an upper surface of the top portion 24 in FIG. 1.

The longitudinal ribs 26 of the upper die 20Z have a plate shape and are provided two between the pair of side walls 25 inside the upper die 20Z, and the longitudinal ribs 26 extend between the bottom portion and the top portion in parallel in the Z direction. In other words, the longitudinal ribs 26 extend perpendicular to the plate surface of the bottom portion 22 and the plate surface of the top portion 24. The thickness of each of the bottom portion 22, the top portion 24, the side walls 25, and the longitudinal ribs 26 of the upper die 20Z is, for example, 40 mm to 80 mm. In the disclosure, the shapes, dimensions, and the like of the bottom portion, the top portion, the side walls, and the longitudinal ribs of the upper die can be appropriately changed.

### Lower Die

The lower die 10 includes a bottom portion 12, a top portion 14, side walls 15, longitudinal ribs 16, and stiffening members 18. The bottom portion 12 and the top portion 14 are connected to each other by the side walls 15, the longitudinal ribs 16, and the stiffening members 18. The bottom portion 12 has a plate shape and is provided on the bolster 50 side (lower side in FIG. 1). The top portion 14 has a plate shape and is provided on the slide 60 side (upper side in FIG. 1) away from the bottom portion 12, and the workpiece 90 is placed on the upper side of the lower die 10. The side walls 15 have a plate shape, are provided at both ends in the X direction (left-right direction in FIG. 1) of the lower die 10, and extend vertically along the Z direction (up-down direction in FIG. 1). Lower ends of the side walls 15, lower ends of the longitudinal ribs 16, and lower ends of the stiffening members 18 are connected to an upper surface of the bottom portion 12 in FIG. 1. Upper ends of the side walls 15, upper ends of the longitudinal ribs 16, and upper ends of the stiffening members 18 are connected to a lower surface of the top portion 14 in FIG. 1.

The longitudinal ribs 16 of the lower die 10 have a plate shape, are provided two between the pair of side walls 15 inside the lower die 10, and extend vertically between the bottom portion and the top portion in parallel with the movable direction of the slide 60. The longitudinal ribs 16 extend perpendicularly to the plate surface of the bottom portion 12 and the plate surface of the top portion 14. The longitudinal ribs 16 of the lower die 10 are provided at positions overlapping the longitudinal ribs 26 of the upper die 20Z in the up-down direction. The thickness of each of the bottom portion 12, the top portion 14, the side walls 15, and the longitudinal ribs 16 of the lower die 10 is, for example, 40 mm to 80 mm. In the disclosure, the shapes, dimensions, and the like of the bottom portion, the top portion, the side walls, and the longitudinal ribs of the lower die can be appropriately changed.

### Stiffening Member

The stiffening members 18 according to the first embodiment have a plate shape, and are disposed in pair across the center of the top portion 14. In the disclosure, the shape and number of the stiffening members 18 can be optionally set. For example, the stiffening member 18 is not limited to a plate shape, and may be a rod shape. In the disclosure, the thickness of the stiffening member 18 can be appropriately set to, for example, ½ times or 2 times the thickness of each of the bottom portion 12, the top portion 14, the side walls 15, and the longitudinal ribs 16 of the lower die 10.

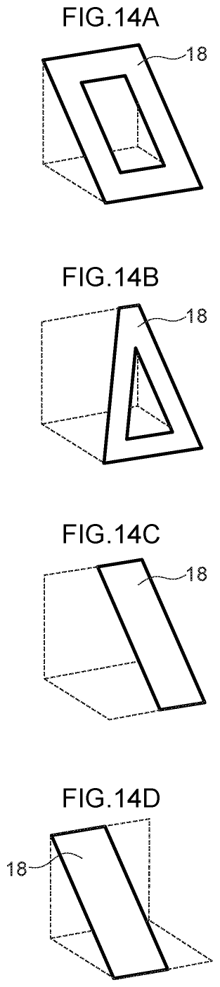

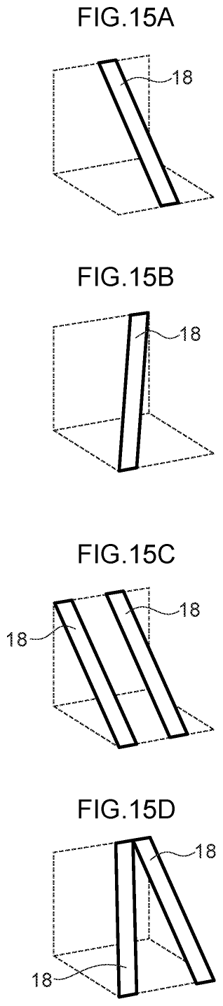

When the stiffening member 18 has a plate shape, the plate may have, for example, a planar shape or a shape provided with irregularities or a step as long as necessary strength is secured. In addition, the stiffening member 18 may be subjected to a lightening process such as formation of a hollow or narrowing. In addition, when the stiffening member has a rod shape, the rod may have, for example, a linear shape or a shape provided with a bend or a step as long as necessary strength is secured. Further, even when the stiffening member has a rod shape, a hollow or the like may be formed in the stiffening member. The shape of the stiffening member subjected to the lightening process will be described later with reference to FIG. 14. The shape of the rod-shaped stiffening member will be described later with reference to FIG. 15.

The stiffening member 18 has one end directly connected to the bottom portion 12 and another end connected to the top portion 14. Although another end on the upper side of the stiffening member 18 illustrated in FIG. 1 is directly connected to the top portion 14, the disclosure is not limited thereto. Another end of the stiffening member 18 may be connected to the center of the longitudinal rib 16 in the up-down direction in FIG. 1, whereby the stiffening member 18 may be indirectly connected to the top portion 14 via the longitudinal rib 16.

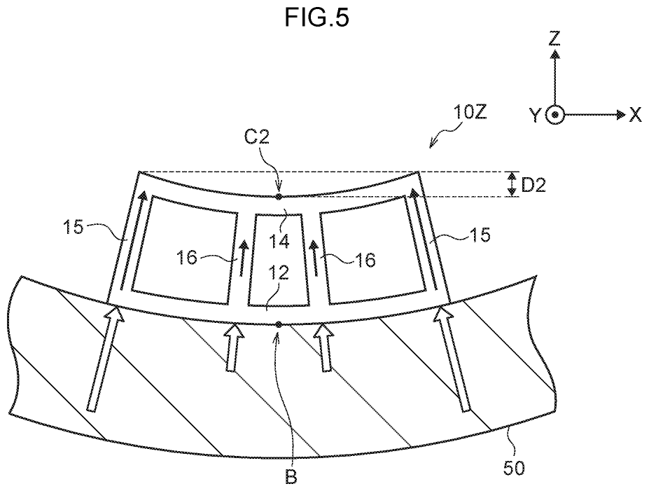

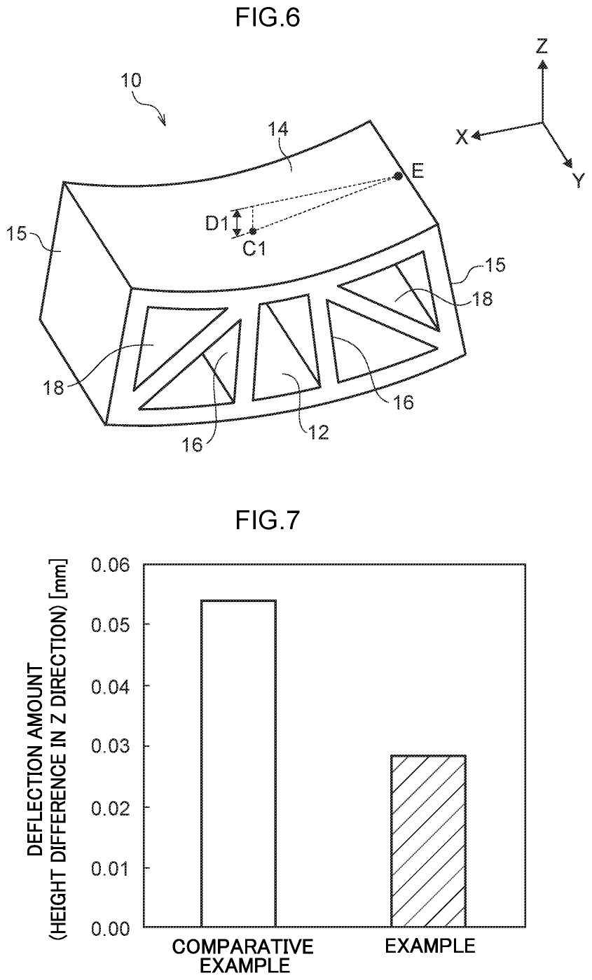

The stiffening member 18 extends in an inclined manner from the connection portion with the bottom portion 12 toward the side on which the center of the top portion 14 is located from the bottom portion 12 toward the top portion 14 side. That is, the shortest distance to the connection portion between the top portion 14 and the stiffening member 18 as measured from the deepest portion C1 (see FIG. 6), which is the center of the top portion 14, is shorter than the shortest distance to the connection portion between the bottom portion 12 and the stiffening member 18 in plan view along the Z direction.

As illustrated in FIG. 1, in the first embodiment, the stiffening member 18 is disposed at a diagonal position of a rectangle formed by the bottom portion 12, the longitudinal rib 16, and the top portion 14. That is, a truss structure is formed in the lower die 10 by the bottom portion 12, the longitudinal rib 16, and the stiffening member 18. However, in the disclosure, the stiffening member is not necessarily disposed at a diagonal position, and the disposition position can be optionally set.

In the first embodiment, the stiffening members 18 are provided in the lower die 10. However, in the disclosure, the stiffening members may be provided in at least one of the lower die and the upper die, or may be provided in both the lower die and the upper die. A die in which the stiffening members are provided only in the upper die will be described in the second embodiment, and a die in which the stiffening members are provided in both the lower die and the upper die will be described in the third embodiment.

Further, the lower die 10 according to the first embodiment can be integrally manufactured by, for example, casting. However, for example, the lower die according to the disclosure can be manufactured by manufacturing the stiffening members 18 separately from the main body of the lower die and attaching the stiffening members 18 to an existing lower die not provided with stiffening members by welding or the like.

### Press-Molding Method

During press molding using the press-molding apparatus 100 including the die 30 according to the first embodiment, as illustrated in FIG. 1, the upper die 20Z with the upper insert 80 attached on the top portion 24 is provided below the slide 60. The lower die 10 with the lower insert 90 attached on the top portion 14 is also provided on the bolster 50. The workpiece 90 is disposed at a predetermined position on the lower insert 90 on the lower die 10 side.

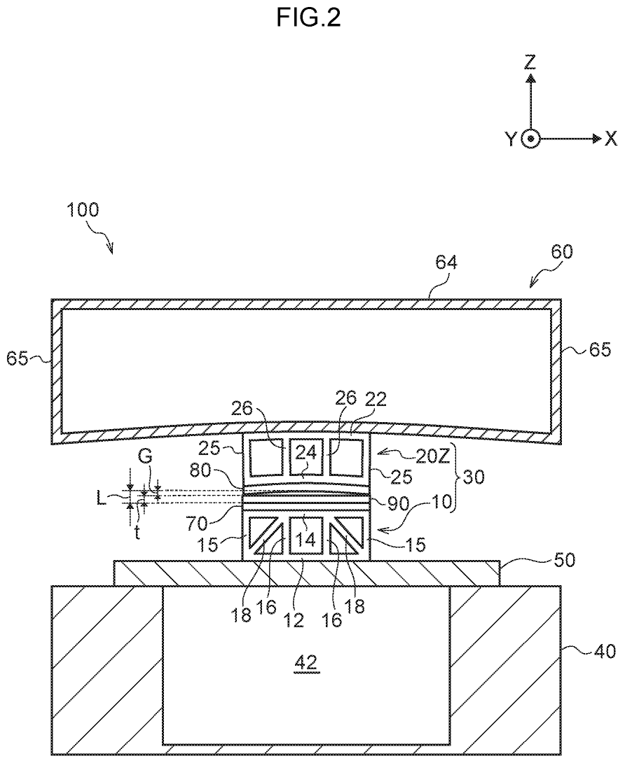

Then, when the slide 60 is lowered, the upper insert 80 comes into contact with the workpiece 90 and the lower insert 90. When a load is applied to the die 30, the workpiece 90 is molded into a desired shape according to the shape of the die face of the die 30. As illustrated in FIG. 2, the bed 40 and the bolster 50 to which a load is applied from the upper side via the die 30 are elastically deformed such that the center protrudes downward due to the influence of the cavity 42 at the molding bottom dead center. Then, as illustrated in FIG. 2, the upper die 20Z is separated from the lower die 10 by the raising of the slide 60.

As illustrated in FIG. 3, during the press molding, a load as a reaction force of the press load is generated inside the pressing machine, and the generated load is transmitted from the bolster 50 to the lower die 10. Here, the lower die 10 is disposed on the bolster 50 so as to overlap the cavity 42 of the bed 40. Therefore, by elastically deforming the center of the top portion 14 so as to protrude downward, bowl-shaped deflection is formed in the top portion 14 of the lower die 10, similarly to the bolster 50. In FIG. 3, the deflection amount D1 of the top portion 14 of the lower die 10 of the first embodiment is illustrated as a height difference between the deepest portion C1 of the deflection of the top portion 14 and the highest position at the outer end portion of the top portion 14 in the Z direction.

In the first embodiment, as illustrated in FIG. 3, the deepest portion B of the deflection of the curved bolster 50 and the deepest portion C1 of the deflection of the top portion 14 of the lower die 10 overlap each other in the up-down direction (Z direction). In addition, the load transmitted from the bolster 50 to the lower die 10 due to the bowl-shaped deflection is larger than the load on the inner side in a region away outward from the deepest portion B of the deflection of the bolster 50 in the bottom portion 12 of the lower die 10. Inside the bolster 50 in FIG. 3, a difference in magnitude of each load is illustrated depending on the length of the outlined arrow.

In the first embodiment, the load transmitted from the region separated outward from the deepest portion B of the bolster 50 to the bottom portion 12 is guided toward the center of the top portion 14 by the stiffening members 18 inclined from the outside toward the side on which the central side is located. That is, the load from the bolster 50 transmitted from the region separated outward from the center of the bottom portion 12 is dispersed without being concentrated on both ends of the top portion 14.

In the first embodiment, a case in which the upper die 20Z also bends at the same time as the lower die 10 during the press molding is illustrated. When a cavity is formed inside the slide 60, the center of the slide 60 may protrude upward and bend due to the load during press molding as illustrated in FIG. 2. Similarly to the relationship between the bolster 50 and the lower die 10, the upper die 20Z can bend due to the difference between the magnitude of the load transmitted from the center of the slide 60 to the upper die 20Z and the magnitude of the load transmitted from the outside to the upper die 20Z.

Therefore, in the first embodiment, a gap is formed between the lower insert 70 and the upper insert 80 in the press-molding apparatus 100 in FIG. 2 in which the slide 60 reaches the molding bottom dead center. In the first embodiment, a length obtained by subtracting the thickness t of the workpiece 90 from the maximum length L measured along the up-down direction between the lower insert 70 and the upper insert 80 in FIG. 2 is defined as a “maximum gap G” (that is, G=L−t). In other words, the maximum gap G is a maximum length in the up-down direction of a region where no member constituting the press-molding apparatus 100 or the workpiece 90 is present. In the first embodiment, the positions where the maximum length L and the maximum gap G are formed overlap with the deepest portion C1 of the top portion 14.

FIG. 2 illustrates a state in which the upper surface of the lower insert 70 is in contact with the lower surface of the workpiece 90 and both the left and right ends of the upper insert 80 are in contact with the workpiece 90. FIG. 2 illustrates a state in which, at the center in the left-right direction, there is almost no gap formed between the upper surface of the lower insert 70 and the lower surface of the workpiece 90, and a gap is formed between the lower surface of the upper insert 80 and the upper surface of the workpiece 90. Therefore, in the present embodiment, the maximum gap G is substantially constituted by a length between the lower surface of the upper insert 80 and the upper surface of the workpiece 90.

However, in the disclosure, the maximum gap is not limited thereto, and is appropriately formed according to the specifications of the press-molding apparatus and the press conditions. In the disclosure, the maximum gap may also be formed by the sum of the maximum length between the lower surface of the upper insert and the upper surface of the workpiece and the maximum length between the upper surface of the lower insert and the lower surface of the workpiece. The maximum gap may also be formed solely by the maximum length between the upper surface of the lower insert and the lower surface of the workpiece.

### Comparative Example

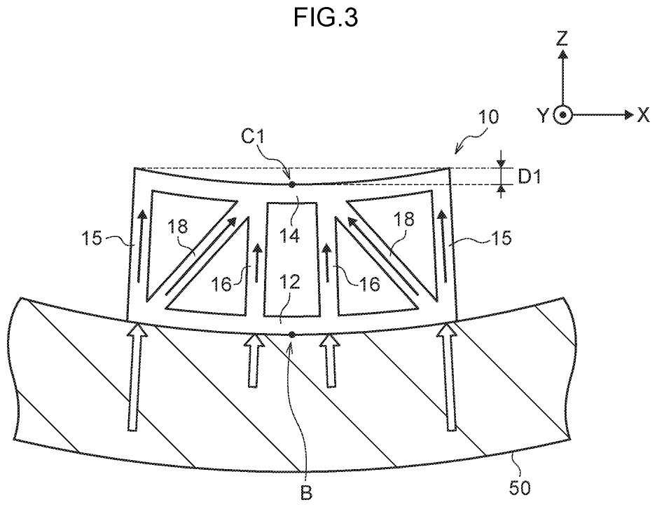

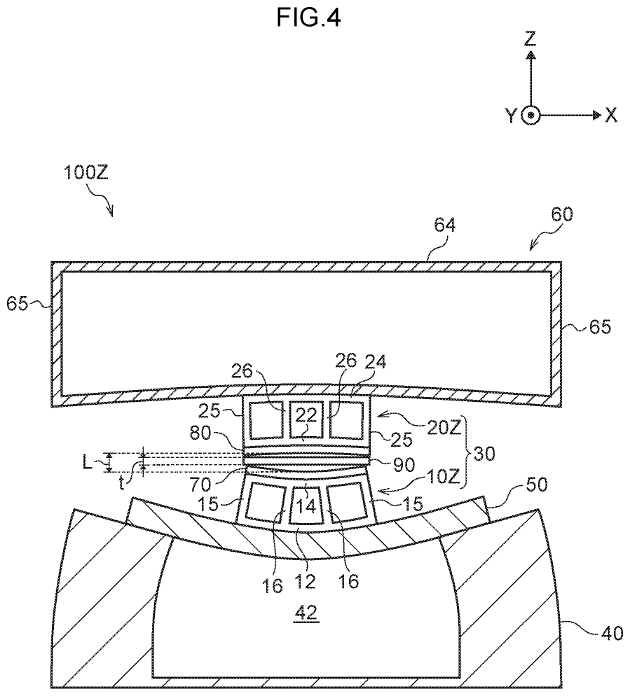

On the other hand, FIG. 4 illustrates a press-molding apparatus 100Z according to a comparative example in which a lower die 10Z provided with only longitudinal ribs 16 is provided without the stiffening members 18. The deflection amount D2 of the top portion 14 of the comparative example is a height difference between the deepest portion C2 of the deflection of the top portion 14 and the highest position at the outer end portion of the top portion 14 in the Z direction in FIG. 5.

In the case of the lower die 10Z of the comparative example, the load from the bolster 50 transmitted from the region separated outward from the center of the bottom portion 12 is guided to both ends of the top portion 14 by the side walls 15 at both ends. In addition, the load from the bolster 50 transmitted to the central side of the bottom portion 12 is transmitted to the center of the top portion 14 via two longitudinal ribs 16 provided between the top portion 14 and the bottom portion 12.

In the case of the lower die 10Z of the comparative example, the load from the bolster 50 transmitted from the region separated outward from the center of the bottom portion 12 is intensively transmitted to both ends of the top portion 14 as compared with the first embodiment. Therefore, the deflection moment acting on the top portion 14 is larger than that in the first embodiment, and the deflection amount D2 of the top portion 14 of the lower die 10Z of the comparative example is larger than the deflection amount D1 of the top portion 14 of the lower die 10 of the first embodiment. In other words, in the lower die 10Z according to the comparative example, the load transmitted from the region separated outward from the deepest portion B of the bolster 50 cannot be sufficiently supported on the central side.

Since the deflection of the top portion 14 of the lower die 10Z increases, the lower insert 70 and the upper insert 80 come into contact with the workpiece 90 only at both end portions in the left-right direction in the press-molding apparatus 100Z according to the comparative example as illustrated in FIG. 4. Further, in the press-molding apparatus 100Z in FIG. 4, a large gap is formed between the lower insert 70 and the workpiece 90 at the center in the left-right direction, unlike the lower die 10 of the first embodiment illustrated in FIG. 2. In the press-molding apparatus 100Z according to the comparative example, the maximum gap is formed by the sum of the maximum length in the up-down direction between the lower surface of the upper insert 80 and the upper surface of the workpiece 90 and the maximum length in the up-down direction between the upper surface of the lower insert 70 and the lower surface of the workpiece 90.

### EXAMPLE

### Calculation of Deflection Amount

As illustrated in FIG. 6, the present inventors created a die model of the lower die 10 according to the present example for analysis. For convenience of description, each component of the die model of the lower die 10 in FIG. 6 is denoted by the same reference numeral as the corresponding component in the actual lower die 10 in FIG. 3.

The dimensions of the die model of the lower die 10 were set to about 1240 mm in the X direction, about 610 mm in the Y direction, and about 422 mm in the Z direction. In addition, two truss structures were formed by providing two stiffening members 18. In addition, the deflection amount D1 is a height difference measured along the Z direction between the deepest portion C1 of the top portion 14 and the virtual position E of the end portion of the rectangle of the top portion 14 in the longitudinal direction (X direction in FIG. 6) in plan view. Further, the deepest portion C1 and the virtual position E are located on a straight line parallel to the X direction in plan view.

In addition, similarly to the die model of the lower die 10 according to the present example, the present inventors created a die model of the lower die 10 according to the comparative example for analysis without the stiffening members 18. Then, the deflection amount D1 of the lower top portion 14 of the example and the deflection amount D2 of the lower top portion 14 of the comparative example were calculated. The molding load was 350 tons in each case.

As shown in FIG. 7, as a result of calculation, the deflection amount D1 at the deepest portion of the top portion 14 of the lower die 10 of the example was 28 In addition, the deflection amount D2 of the deepest portion of the top portion 14 of the lower die of the comparative example was 54 μm. That is, when the deflection amount D2 of the comparative example was 100%, the deflection amount D1 of the example could be suppressed to about 50% of the comparative example.

Note that the values disclosed in the above example are examples, and the deflection amounts are not limited thereto in the disclosure. The deflection amounts can change depending on molding conditions such as a pressing machine, a die face, a mold structure, and a load. For example, in the case of the example, the calculated deflection amount difference was a micron-order value, but depending on the conditions, a deflection amount difference of 1 mm or more may also occur.

### Calculation of Maximum Gap

In addition, the present inventors calculated the maximum gap G formed between the upper die 20Z and the lower die 10 in each of the example and the comparative example. As a result of the calculation, in the example, the maximum gap G could be reduced by several tens of microns as compared with the comparative example. Similarly to the case of the deflection amount, the value of the maximum gap G is not limited to the value of the above example. In the disclosure, the maximum gap G can change depending on the molding conditions, for example, about several tens of μm to several mm.

### Operations and Effects

The lower die 10 according to the first embodiment includes the stiffening members 18 having one end directly connected to the bottom portion 12 and another end connected to the top portion 14, and the stiffening members 18 extend from the connection portion with the bottom portion 12 toward the side on which the center of the top portion 14 is located from the bottom portion 12 side toward the top portion 14 side.

Therefore, even if the center of the bolster 50 bends in a bowl shape protruding downward during press molding, the load transmitted from the bolster 50 to the lower die 10 is guided to the central side of the plate-shaped top portion 14 by the stiffening members 18 inside the lower die 10. The stiffening members 18 have one end directly connected to the bottom portion 12 and another end connected to the top portion 14. Therefore, the load induced by the stiffening members 18 is efficiently utilized as a force against deflection at the center of the top portion 14. In other words, the load transmitted from the bolster 50 to be biased outward at the bottom portion 12 of the lower die 10 is dispersed by the stiffening members 18 so that the bias between the center and the outside is suppressed at the top portion 14.

As a result, the rigidity of the top portion 14 of the lower die 10 is reinforced as compared with the lower die in which only the vertical longitudinal ribs 16 extending in parallel along the movable direction of the slide 60 are provided between the top portion 14 and the bottom portion 12, so that the deflection of the top portion 14 on the workpiece side of the lower die 10 can be suppressed.

In the first embodiment, it is only necessary to provide the stiffening members 18 in the lower die 10 as an improvement of the die, and it is not necessary to improve the configuration on the pressing machine side even if the pressing machine bends. In addition, since it is only necessary to provide the stiffening members 18 as the improvement work of the lower die 10, the improvement work is relatively easy.

Therefore, according to the first embodiment, it is not necessary to improve the configuration on the pressing machine side, and the deflection of the upper surface of the lower die 10 can be suppressed by directly improving the lower die 10 itself relatively easily.

In addition, there is usually a problem that the larger the deflection of the lower die, the larger the burden of developing the die. Specifically, for example, when an actual die (actual machine) is developed, a die model is first constructed by press molding simulation (analysis) for mold structure design. Here, in the case of a rigid body die model (CAE) analysis assuming that the die is a rigid body, it is assumed that the die face does not bend.

However, since the die actually bends, a difference in configuration between the die model and the actual die increases. For this reason, it is necessary to correct the die model in consideration of the deflection, but since the calculation work related to the correction becomes complicated, the calculation time becomes longer and the calculation cost becomes higher, and as a result, the burden of developing the die increases.

In addition, since the calculation work becomes complicated, it is difficult to accurately reproduce the die model, resulting in low reproducibility of the die model. That is, the difference between the actual machine having the necessary structure and the die model for analysis increases. In addition, problems such as the burden of die development and low reproducibility become more significant as the molding load increases.

However, according to the first embodiment, the die face is supported by the stiffening members 18, and the load can be appropriately transmitted to the die face. Therefore, even if the bolster 50 bends, deformation of the die face can be reduced, so that the burden of developing the die is reduced.

As described in the example of the first embodiment, when the deflection amount D2 of the comparative example is assumed to be 100%, the deflection amount D1 of the example can be suppressed to about 50% of the comparative example. Therefore, assuming that the difference between the comparative example and the rigid body die model is 100% with respect to the spring back amount generated in the product press-molded using the die 30 in the press molding simulation, the difference between the example and the rigid body die model is suppressed to 50%. That is, according to the first embodiment, the prediction accuracy of numerical analysis is improved. Therefore, since the difference between the die of the actual machine and the die model for analysis is suppressed, the reproducibility of the simulation can be improved.

In the first embodiment, since the pair of stiffening members 18 is disposed across the center of the top portion 14, a load is induced not only from one side but also from both sides with respect to the center of the top portion 14 during press molding. Therefore, the deflection of the top portion 14 can be suppressed in a balanced manner while reducing the bias.

In the first embodiment, since the truss structures are formed by the longitudinal ribs 16, the bottom portion 12, and the stiffening members 18, the rigidity of the lower die 10 can be further improved.

Further, in the press-molding apparatus 100 according to the first embodiment, since the die 30 including the lower die 10 having the stiffening members 18 is used, the deflection of the lower die 10 can be effectively suppressed, and as a result, moldability and dimensional accuracy of the molded product can be improved.

Further, in the press-molding apparatus 100 according to the first embodiment, in the lower die 10, the stiffening members 18 connected to the bottom portion 12 and the top portion 14 are integrally formed with the bottom portion 12 and the top portion 14, so that the lower die 10 can be efficiently manufactured. In addition, by fixing the stiffening members 18 separately formed as separate bodies from the bottom portion 12 and the top portion 14 to the existing lower die having no stiffening member by welding or the like, it is possible to effectively utilize the lower die of the existing equipment without discarding the lower die. Note that the lower die of the disclosure may be configured by adding the stiffening member 18 as a separate body later to the lower die 10 already formed with the stiffening member 18.

### Modification

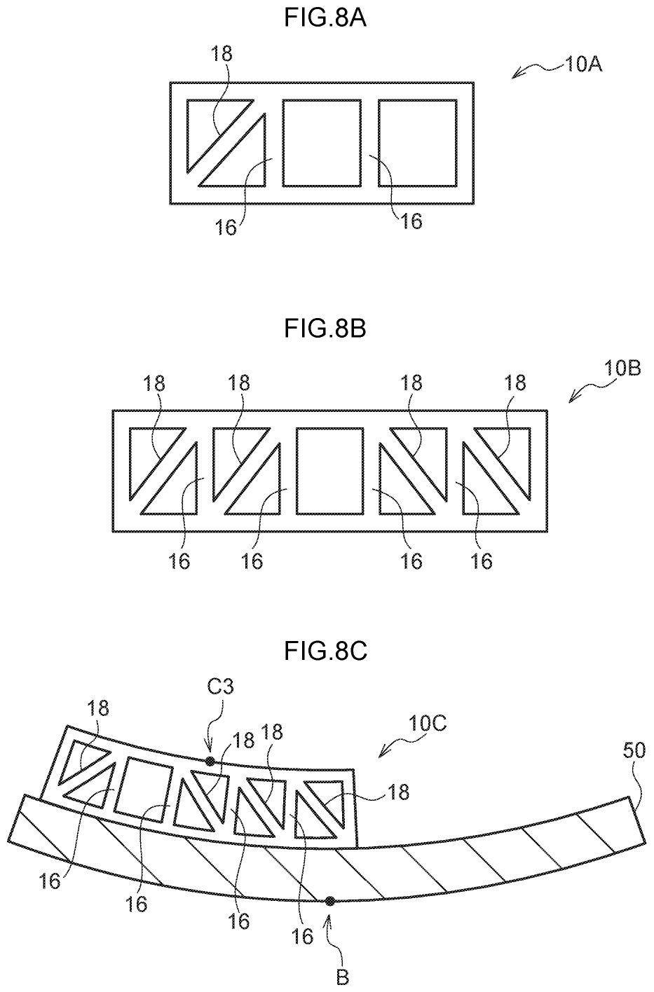

Next, a modification of the first embodiment will be described with reference to FIGS. 8 to 16. In the die 30 according to the following modification, a configuration different from the die 30 described with reference to FIGS. 1 to 7 will be mainly described. In addition, in each modification, redundant description of the configuration of the same portion as the die 30 described with reference to FIGS. 1 to 7 will be omitted.

As illustrated in FIG. 8A, the stiffening member 18 may be provided only on one of left and right sides of the center of a lower die 10A. FIG. 8B illustrates two pairs of stiffening members 18 sandwiching the center of a lower die 10B. That is, in the disclosure, a plurality of pairs of stiffening members 18 may be provided, or a plurality of stiffening members may be provided in a non-paired state. In addition, as illustrated in FIG. 8C, the deepest portion B of the deflection of the bolster 50 and the center C3 of a top portion of a lower die 10C may be displaced from each other during the press molding. That is, the deepest portion B of the deflection of the bolster 50 and the center C3 of the top portion of the lower die 10C may not be disposed coaxially. In FIG. 8C, the bolster 50 is drawn in a cut state for the sake of clarity.

The second stiffening member 18 from the left side among the four stiffening members 18 in FIG. 8C extends in an inclined manner from the connection portion with the bottom portion toward the outside of the center C3 of the top portion from the bottom portion on the lower side toward the top portion on the upper side. Therefore, the second stiffening member 18 from the left side in FIG. 8C does not appear to extend in an inclined manner toward the side on which the center is located only in a front view. However, in the disclosure, when the plurality of stiffening members are included in the die, it is sufficient that some of the stiffening members extend in an inclined manner from the connection portion with the bottom portion toward the side on which the center of the top portion is located from the bottom portion toward the top portion. It is sufficient that the load during the press molding can be guided from the bottom portion to the central side of the top portion as a whole by the plurality of stiffening members.

In the case of the lower die 10C in FIG. 8C, among the four stiffening members 18, all three stiffening members 18 including two on the right side and one on the left side extend in an inclined manner from the connection portion with the bottom portion toward the side on which the center of the top portion is located from the bottom portion on the lower side toward the top portion on the upper side. Therefore, even if the lower die 10C in FIG. 8C has one second stiffening member 18 from the left side that does not extend in an inclined manner toward the side on which the center of the top portion is located, the load during press molding can be guided from the bottom portion to the central side of the top portion as a whole of the four stiffening members 18. Therefore, the lower die 10C in FIG. 8C corresponds to the lower die of the disclosure.

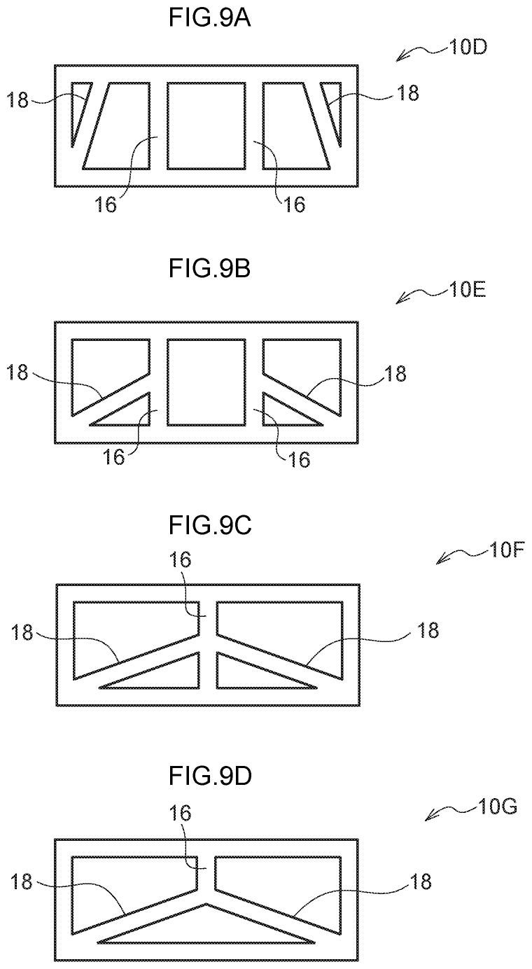

In the disclosure, the stiffening members 18 may not be connected to some or all of the longitudinal ribs 16 provided in a lower die 10D. FIG. 9A illustrates the stiffening members 18 that are not connected to all the two longitudinal ribs 16 provided in the lower die 10D. It is sufficient that the stiffening members 18 can guide a load from the bolster 50 side to the center of the top portion 14. As illustrated in FIG. 9B, in a lower die 10E, the upper portions of the stiffening members 18 may be connected to a region of the center height of the vertically extending longitudinal rib 16 such that the stiffening members 18 support the longitudinal rib 16. That is, formation of the truss structure is not essential.

Further, as illustrated in FIG. 9C, in a lower die 10F, one longitudinal rib 16 may be provided at the center in the left-right direction, the upper portions of the two stiffening members 18 may be connected to the region of the center height of the longitudinal rib 16, and the two stiffening members 18 may support one longitudinal rib 16 from both sides. In the case of the lower die 10F in FIG. 9C, the stiffening members 18 are connected to the top portion 14 via the longitudinal ribs 16. Although not illustrated, for example, in the region on the left side of the longitudinal rib 16 located at the center in the left-right direction in FIG. 9C, the stiffening member 18 extending from the lower left corner toward the upper right may further continuously extend in the region on the right side of the longitudinal rib 16 beyond the position of the longitudinal rib 16.

As illustrated in FIG. 9D, the upper portions of the two stiffening members 18 may be connected at the center in the left-right direction and at the center in the up-down direction of a lower die 10G. One longitudinal rib 16 may be provided so as to extend upward from the connection portion of the two stiffening members 18. In the lower die 10G, the two stiffening members 18 support the upper longitudinal rib 16 from below and are connected to the top portion 14 via the longitudinal rib 16. Note that the longitudinal rib 16 in FIG. 9D is an auxiliary longitudinal rib whose lower portion is not connected to the bottom portion, unlike the longitudinal ribs 16 illustrated in FIGS. 9A to 9C.

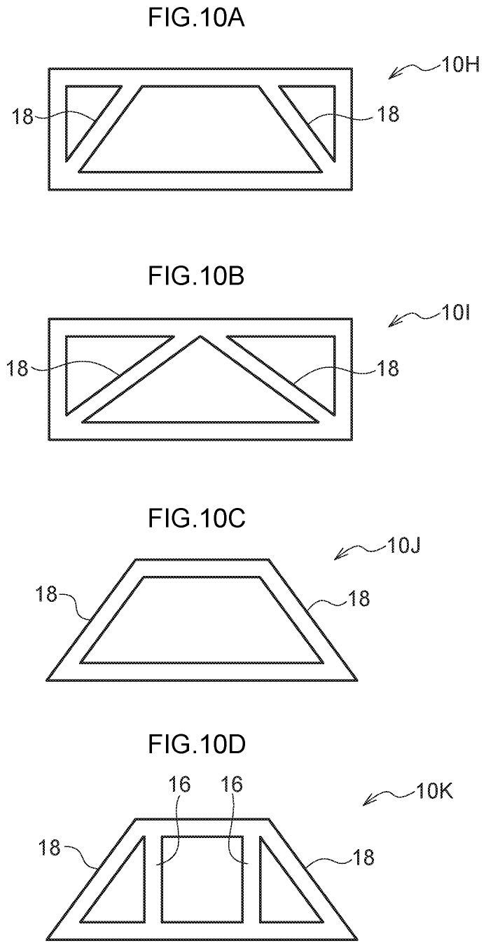

As illustrated in FIG. 10A, a lower die 10H may be provided with only the stiffening members 18 inside without providing the longitudinal rib 16. Further, as illustrated in FIG. 10B, in a state where no longitudinal rib 16 is provided, the upper portions of the two stiffening members 18 may be connected close to each other at the center of the lower die 10I in the left-right direction and to the top portion 14.

As illustrated in FIG. 10C, a lower die 10J may not be provided with side walls as members separate from the stiffening members 18. In the lower die 10J illustrated in FIG. 10C, the stiffening members 18 form left and right outer edges, so that the entire outer edge has a trapezoidal shape. Further, as illustrated in FIG. 10D, the longitudinal ribs 16 may be provided inside a lower die 10K having a trapezoidal shape on the entire outer edge.

Note that the longitudinal rib 16 does not have a function of guiding an outer load to the center unlike the stiffening member 18, and thus is not essential in the disclosure. However, when the longitudinal rib is disposed at the center of the die, in a load range where the molding load is relatively low, a function of effectively transmitting the load transmitted from the bolster 50 to the top portion can be secured to a certain extent. Therefore, in the low load range, it is preferable to provide the longitudinal rib 16 and the stiffening member 18 in combination from the viewpoint of being able to assist the function of the stiffening member 18.

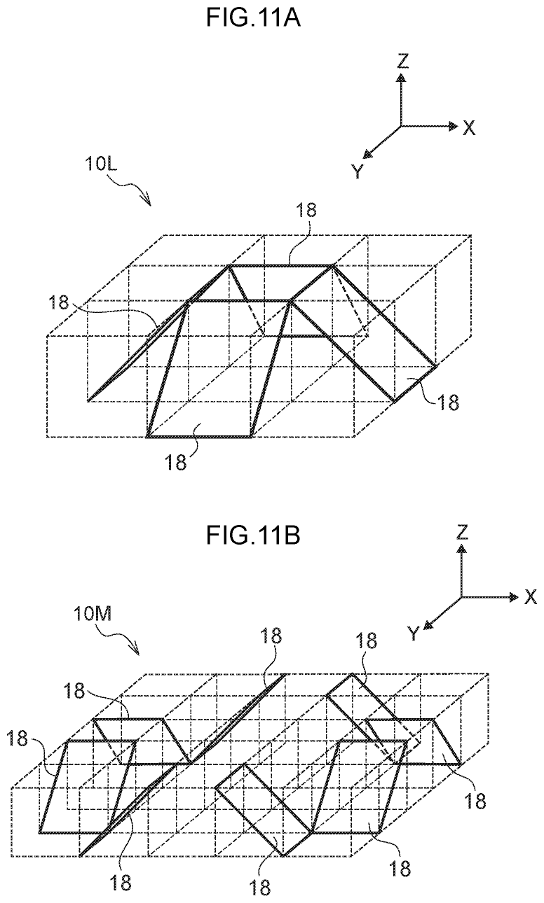

Although the shape of the stiffening member 18 according to the modification illustrated in FIGS. 1 to 10 is drawn in a two-dimensional (planar) shape, the stiffening member 18 according to the disclosure actually exists in a direction (Y direction) orthogonal to the plane (ZX plane) as illustrated in FIGS. 11 to 15. That is, the stiffening member 18 is three-dimensionally disposed inside the lower die 10. In FIGS. 11 to 15, for the sake of clarity, the top portion of the lower die is not illustrated, and only the contour of the stiffening member 18 is illustrated by a solid line, and only the contours of the bottom portion and the longitudinal rib are illustrated by broken lines.

A lower die 10L in FIG. 11A has four longitudinal ribs. On the inner side of the lower die 10L, nine sections are formed by providing four longitudinal ribs including two longitudinal ribs along the X direction and two longitudinal ribs along the Y direction with spaces therebetween. As illustrated in FIG. 11A, in the disclosure, a plurality of stiffening members 18 may be provided so as to surround the center of top portion 14. In the lower die 10L in FIG. 11A, four plate-shaped stiffening members 18 are disposed so as to surround the center of the top portion. In addition, the four stiffening members 18 are disposed so as to form rotational symmetry of 90 degrees in a plan view in which the XY plane is viewed from the Z direction. Each stiffening member 18 extends from the upper surface of the bottom portion 12 along the XY plane toward the center of the bottom portion 12 along the Z direction.

A lower die 10M in FIG. 11B has sixteen longitudinal ribs. On the inner side of the lower die 10M, twenty-five sections are formed by providing sixteen longitudinal ribs including four longitudinal ribs along the X direction and four longitudinal ribs along the Y direction with spaces therebetween. The lower die 10M has a rectangular shape in a plan view, and the eight stiffening members 18 are disposed so that two stiffening members 18 are disposed in each of outer sections corresponding to the four sides of the rectangle in a state where rotational symmetry of 90 degrees is formed. The stiffening members 18 are disposed in two sections sandwiched between both ends and the center among five sections seen when the lower die 10M is viewed from the front or the side. In the disclosure, the angle of rotational symmetry of the stiffening members 18 is not limited to 90 degrees, and can be changed as appropriate. In the disclosure, the rotationally symmetric arrangement of the stiffening members 18 is not essential.

Like the stiffening members 18 of the lower die 10M illustrated in FIG. 11B, it is not required in the disclosure that the stiffening member extends toward the center of the top portion itself. When the inclined state of the stiffening member 18 of the lower die 10M is viewed along the X direction or the Y direction, the stiffening member 18 extends from the connection portion with the bottom portion toward the side on which the center of the top portion is located. In addition, the shortest distance to the connection portion between the top portion and the stiffening member 18 as measured from the center of the top portion is shorter than the shortest distance to the connection portion between the bottom portion and the stiffening member 18 in plan view.

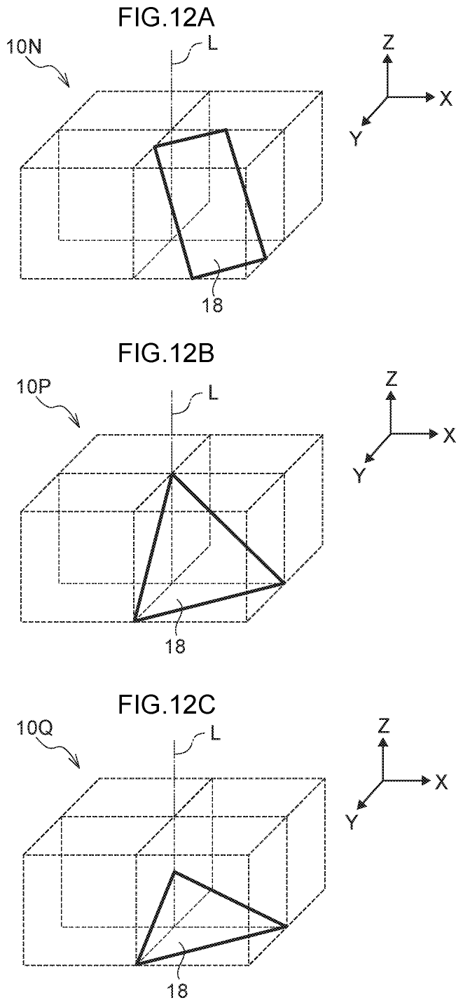

The plate-shaped stiffening member 18 in FIGS. 11A and 11B has a rectangular shape, and one side of the rectangle at the portion connected to the bottom portion and one side of the rectangle at the portion connected to the top portion extend parallel to the X direction or the Y direction. However, like the stiffening member 18 of a lower die 10N illustrated in FIG. 12A, in the disclosure, one side of the rectangle of the stiffening member 18 may intersect the X direction and the Y direction.

In addition, like the stiffening member 18 of a lower die 10P illustrated in FIG. 12B, the shape of the stiffening member may be a triangular shape instead of a rectangular shape. Further, like the stiffening member 18 of a lower die 10Q illustrated in FIG. 12C, an upper portion of the triangular stiffening member 18 may be connected to a region of the center height of the longitudinal rib 16 and may be connected to the top portion 14 via the longitudinal rib 16.

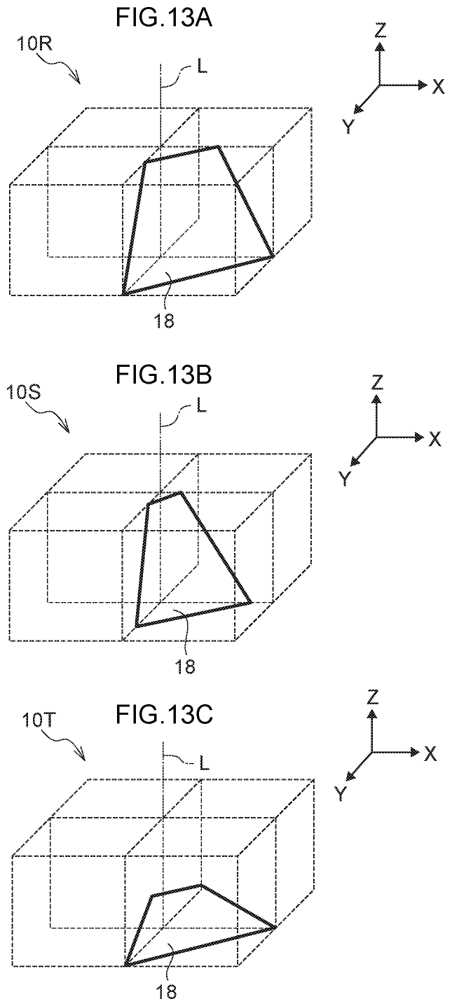

Note that each of the lower dies in FIGS. 12 and 13 has a rectangular shape in plan view, and the central axis L is illustrated in each drawing for convenience of description. The central axis L can be set as a virtual line passing through the center of gravity of the lower die and extending along the Z direction (vertical direction) when the lower die is placed on a horizontal plane.

Further, like the stiffening member 18 of a lower die 10R illustrated in FIG. 13(A), the shape of the stiffening member may be a trapezoidal shape. As illustrated in FIG. 13(B), both ends of the lower bottom portion of the trapezoidal stiffening member 18 may stay inside without extending to an outer edge of a lower die 10S. Further, like the stiffening member 18 of a lower die 10T illustrated in FIG. 13(C), both ends of the upper bottom portion of the trapezoidal stiffening member 18 may be connected to regions of the center heights of the adjacent longitudinal ribs 16, and the stiffening member 18 may be connected to the top portion 14 via the longitudinal ribs 16.

FIGS. 14A to 14D illustrate the stiffening member 18 subjected to a lightening process. In the center of the plate surface of the rectangular stiffening member 18 in FIG. 14A, a rectangular hole is formed as a hollow portion by a lightening process. In FIG. 14A, the stiffening member 18 has a frame shape, and an outer edge of the stiffening member 18 has a rectangular shape.

Further, in the center of the plate surface of the triangular stiffening member 18 in FIG. 14B, a triangular hole is formed as a hollow portion by a lightening process. In FIG. 14B, the stiffening member 18 has a frame shape, and an outer edge of the stiffening member 18 has a triangular shape. In the disclosure, it is preferable that the corner of the hole of the hollow portion is not sharp but rounded in consideration of durability of the stiffening member.

In addition, the width of one lower end of the rectangular stiffening member 18 in FIG. 14C is reduced to about half the width of the bottom portion in the left-right direction by the lightening process. In addition, the width of another end on the upper side of the rectangular stiffening member 18 in FIG. 14C is reduced to about half the width of the top portion in the left-right direction by the lightening process. The narrowed rectangular stiffening member 18 in FIG. 14C is disposed with the right end of the stiffening member 18 aligned with the right end of the bottom portion and the right end of the top portion.

In addition, the width of one lower end of the rectangular stiffening member 18 in FIG. 14D is reduced to about half the width of the bottom portion in the left-right direction by the lightening process. In addition, the width of another end on the upper side of the rectangular stiffening member 18 in FIG. 14D is reduced to about half the width of the top portion in the left-right direction by the lightening process. The narrowed rectangular stiffening member 18 in FIG. 14D is disposed with the left end of the stiffening member 18 aligned with the left end of the bottom portion and the left end of the top portion.

FIGS. 15A to 15D illustrate the rod-shaped stiffening member 18. In the disclosure, the “rod-shaped stiffening member” may include a plate-shaped stiffening member having a reduced width. That is, the plate-shaped stiffening member having a reduced width may be expressed as a “rod shape”.

As illustrated in FIG. 15A, one lower end of the rod-shaped stiffening member 18 is connected to the center of the bottom portion in the left-right direction, and the other upper end of the rod-shaped stiffening member 18 is connected to the center of the top portion in the left-right direction. As illustrated in FIG. 15B, one lower end of the rod-shaped stiffening member 18 is connected to the left end of the bottom portion, and the other upper end of the rod-shaped stiffening member 18 is connected to the right end of the top portion.

As illustrated in FIG. 15C, two rod-shaped stiffening members 18 may be provided in parallel. In FIG. 15C, one lower end of the right rod-shaped stiffening member 18 is connected to the center of the bottom portion in the left-right direction, and the other upper end of the right rod-shaped stiffening member 18 is connected to the center of the top portion in the left-right direction. In FIG. 15C, one lower end of the left rod-shaped stiffening member 18 is connected to the left end of the bottom portion, and the other upper end of the left rod-shaped stiffening member 18 is connected to the left end of the top portion.

As illustrated in FIG. 15D, two rod-shaped stiffening members 18 may be provided so as to intersect each other. In FIG. 15D, one lower end of the right rod-shaped stiffening member 18 is connected to the right end of the bottom portion, and the other upper end of the right rod-shaped stiffening member 18 is connected to the right end of the top portion. In addition, in FIG. 15D, one lower end of the left rod-shaped stiffening member 18 is connected to the left end of the bottom portion, and the other upper end of the left rod-shaped stiffening member 18 is connected to the left side of the top portion in a state of being in contact with the other upper end of the right rod-shaped stiffening member 18.

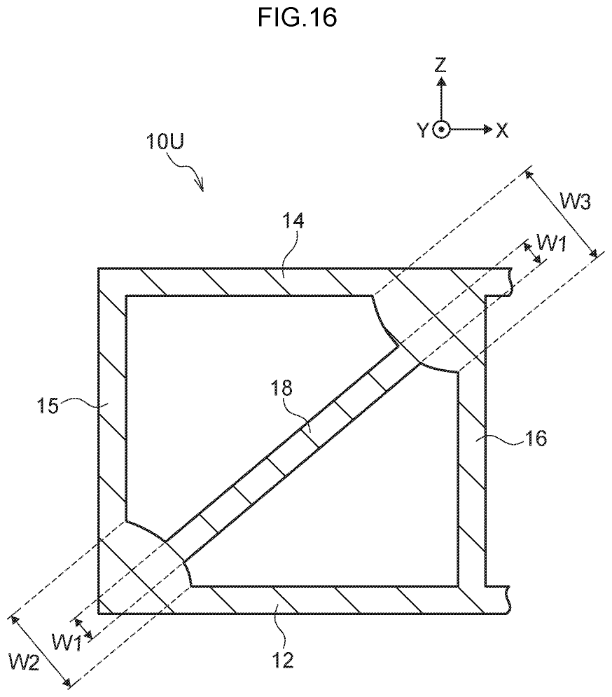

Further, as illustrated in FIG. 16, a connection portion with the bottom portion 12 which is a root of the stiffening member 18 may be widened from a central region of the stiffening member 18. In a lower die 10U illustrated in FIG. 16, the width W2 of the connection portion with the bottom portion 12 of the stiffening member 18 is larger than the width W1 of the central region of the stiffening member 18. Therefore, the rigidity of the lower die 10U can be further improved.

As illustrated in FIG. 16, the connection portion of the upper side of the stiffening member 18 with the top portion 14 may be wider than the central region of the stiffening member 18. In the lower die 10U illustrated in FIG. 16, the width W3 of the connection portion with the top portion 14 of the stiffening member 18 is larger than the width W1 of the central region of the stiffening member 18. Therefore, the rigidity of the lower die 10U can be further improved as compared with the case in which only the connection portion with the bottom portion 12 of the stiffening member 18 is wider than the central region of the stiffening member 18.

The width W1 of the central region of the stiffening member 18, the width W2 of the connection portion with the bottom portion 12, and the width W3 of the connection portion with the top portion 14 are widths measured along the thickness direction of the stiffening member 18 in a cross-sectional view or a front view. In addition, in the stiffening member 18 in FIG. 16, the case in which both the connection portion with the bottom portion 12 and the connection portion with the top portion 14 are widened has been illustrated, but the disclosure is not limited thereto, and only either one may be widened. The width W2 of the connection portion with the bottom portion 12 of the stiffening member 18 and the width W3 of the connection portion with the top portion 14 of the stiffening member 18 may be the same or different from each other, and can be optionally set.

### Second Embodiment

### Structure of Press-Molding Apparatus

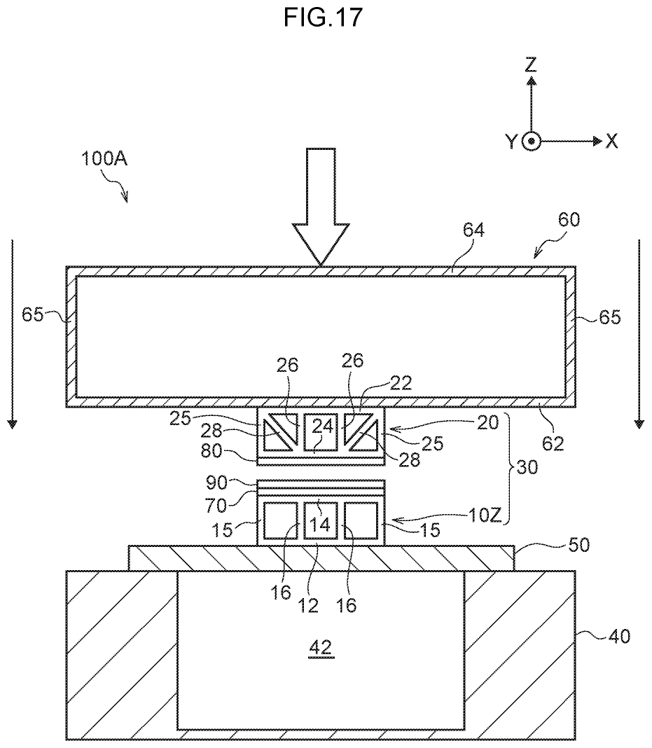

Next, a press-molding apparatus 100A according to a second embodiment will be described with reference to FIG. 17. The press-molding apparatus 100A according to the second embodiment is the same as the press-molding apparatus 100 illustrated in FIG. 1 in that the press-molding apparatus 100A includes a bed 40, a bolster 50, a die 30, and a slide 60, and the die 30 includes a lower die 10Z and an upper die 20. However, as illustrated in FIG. 17, the present embodiment is different from the first embodiment in that no stiffening members 18 are provided in the lower die 10Z of the die 30 and stiffening members 28 are provided in the upper die 20.

As illustrated in FIG. 17, a pair of stiffening members 28 is disposed in the upper die 20 across the center of the top portion 24. Each of the stiffening members 28 extends from the connection portion with the bottom portion 22 toward the side on which the center of the top portion 24 in the left-right direction (X direction) is located from the upper bottom portion 22 side toward the lower top portion 24 side in the Z direction. The stiffening member 28 forms a truss structure inside the upper die 20.

The upper die 20 according to the second embodiment can be manufactured by, for example, casting similarly to the lower die 10 according to the first embodiment. The upper die 20 can also be manufactured by manufacturing the stiffening members 28 separately from the main body of the upper die and attaching the stiffening members 28 to an existing upper die not provided with stiffening members by welding or the like. Since the configurations of the other members of the press-molding apparatus 100A according to the second embodiment are similar to the configurations of the members having the same names in the press-molding apparatus 100 according to the first embodiment, redundant description will be omitted. In addition, since a press-molding method using the press-molding apparatus 100A according to the second embodiment is also similar to the case of the press-molding method using the press-molding apparatus 100 according to the first embodiment, redundant description will be omitted.

### Operations and Effects

In the second embodiment, as described with reference to FIG. 2 in the first embodiment, since the cavity is formed inside the slide 60, the center of the slide 60 bends into a bowl shape protruding upward by a load during press molding. Similarly to the relationship between the bolster 50 and the lower die 10 described in the first embodiment, the lower surface of the upper die 20 on the workpiece side bends due to the difference between the magnitude of the load transmitted from the center of the slide 60 to the upper die 20 and the magnitude of the load transmitted from the outside to the upper die 20.

However, in the inside of the upper die 20 according to the second embodiment, the load transmitted from the slide 60 to the upper die 20 during the press molding is guided to the central side of the plate-shaped top portion 24 by the stiffening members 28. The induced load is efficiently utilized as a force against deflection at the center of the top portion 24. As a result, similarly to the case of the lower die 10 according to the first embodiment, the rigidity of the top portion 24 is reinforced as compared with the upper die provided with only the vertical longitudinal ribs 26, so that the deflection of the top portion 24 on the workpiece side of the upper die 20 can be suppressed.

In addition, similarly to the case of the lower die 10 according to the first embodiment, it is only necessary to provide the stiffening members 28 in the upper die 20 as an improvement of the die, and it is not necessary to improve the configuration on the pressing machine side even if the pressing machine bends. In addition, since it is only necessary to provide the stiffening members 28 as the improvement work of the upper die 20, the improvement work is relatively easy.

Therefore, according to the second embodiment, it is not necessary to improve the configuration on the pressing machine side, and the deflection of the lower surface on the workpiece side of the upper die 20 can be suppressed by directly improving the upper die 20 itself relatively easily. The other operations and effects of the upper die 20 of the press-molding apparatus 100A according to the second embodiment are the same as those of the lower die 10 according to the first embodiment.

### Third Embodiment

### Structure of Press-Molding Apparatus

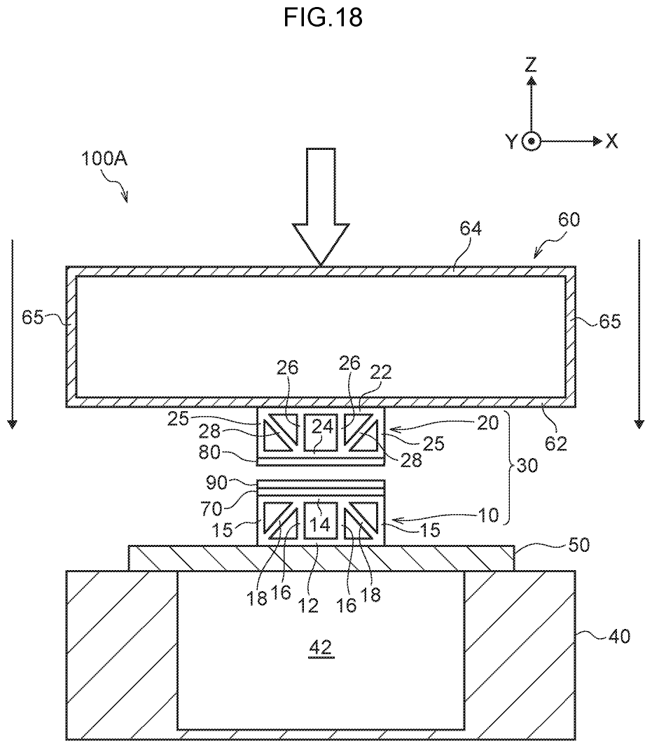

Next, a press-molding apparatus 100B according to a third embodiment will be described with reference to FIG. 18. The press-molding apparatus 100B according to the third embodiment is the same as the press-molding apparatus 100 illustrated in FIG. 1 in that the press-molding apparatus 100B includes a bed 40, a bolster 50, a die 30, and a slide 60, and the die 30 includes a lower die 10 and an upper die 20. However, as illustrated in FIG. 18, the present embodiment is different from the first embodiment in that the stiffening members 28 are provided in the upper die 20 of the die 30, so that both the lower die 10 and the upper die 20 include the stiffening members.

The upper die 20 according to the third embodiment can be manufactured by, for example, casting similarly to the upper die 20 according to the second embodiment. The upper die 20 can also be manufactured by manufacturing the stiffening members 28 separately from the main body of the upper die and attaching the stiffening members 28 to an existing upper die not provided with stiffening members by welding or the like.

Since the configurations of the other members of the press-molding apparatus 100B according to the third embodiment are similar to the configurations of the members having the same names in the first embodiment and the second embodiment, redundant description will be omitted. In addition, since a press-molding method using the press-molding apparatus 100B according to the third embodiment is also similar to the press-molding method in the first embodiment and the second embodiment, redundant description will be omitted.

### Operations and Effects

In the third embodiment, the rigidity of the top portion 14 of the lower die 10 is reinforced by the stiffening members 18, and the rigidity of the top portion 24 of the upper die 20 is reinforced by the stiffening members 28. Therefore, according to the third embodiment, it is not necessary to improve the configuration on the pressing machine side, and both the deflection of the upper surface on the workpiece side of the lower die 10 and the deflection of the lower surface on the workpiece side of the upper die 20 can be suppressed by directly improving the lower die 10 and the upper die 20 themselves relatively easily. The other operations and effects of the press-molding apparatus 100B according to the third embodiment are the same as those of the first embodiment and the second embodiment.

### Other Embodiments

Although the disclosure has been described with reference to the above disclosed embodiments, this description does not limit the disclosure. It should be understood that various alternative embodiments, examples, and operation techniques will become apparent to those skilled in the art from the disclosure. For example, in the present embodiment, the case of press molding applied to bending or drawing has been exemplarily described as a molding technique in which a die is used, but the disclosure is not limited thereto. The disclosure can also be applied to other press molding techniques such as punching, cutting, and burring as long as the deflection of the die can be suppressed.

In addition, the names of the bed 40, the bolster 50, and the slide 60, which are the pressing machine used in the description of the present embodiment, are examples, and in the disclosure, the names are not limited as long as they are members having substantially similar functions. In addition, it is not hindered to add a device or equipment for press molding which is not disclosed in the specification.

In addition, in the die 30 illustrated in FIG. 1, the press-molding apparatus 100 in a case in which the lower die 10 as the first die and the upper die 20Z as the second die are disposed to face each other in the up-down direction is illustrated. However, the disclosure is not limited to the state in which the first die and the second die are disposed to face each other. The first die and the second die may be disposed to face each other in the horizontal direction, or may be disposed to face each other such that a virtual line connecting centers of top portions of the first die and the second die is inclined with respect to the horizontal direction.

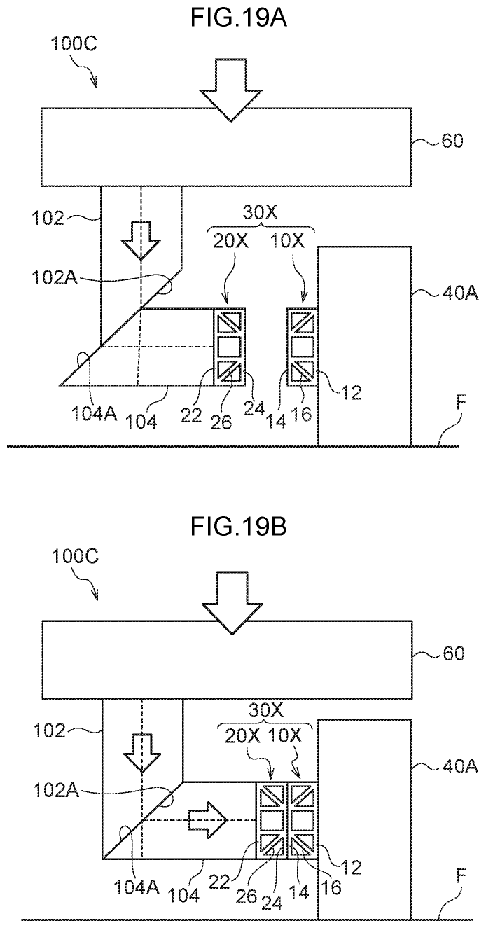

FIG. 19A illustrates a press-molding apparatus 100C in a case in which a first die 10X and a second die 20X of a die 30X are disposed to face each other in the horizontal direction. As illustrated in FIG. 19A, the press-molding apparatus 100C includes a box-shaped support device 40A placed on a floor F, and the first die 10X is supported on the wall surface of the left side wall of the support device 40A such that the bottom portion 12 is located on the support device 40A side. Also in the press-molding apparatus 100C in FIG. 19A, similarly to the first to third embodiments, the die 30X is disposed between the support device 40A and the slide 60. Although not illustrated, the inside of the support device 40A is hollow.

Further, the slide 60 is provided on the upper side of the support device 40A in FIG. 19A, and a first cam member 102 extending downward is attached to the lower surface of the slide 60. On the lower side of the first cam member 102, a second cam member 104 is supported by a support member (not illustrated) so as to be movable in the horizontal direction in the air. The second die 20X is supported at the right end of the second cam member 104 in FIG. 19A such that the bottom portion 22 is located on the second cam member 104 side.

As illustrated in FIG. 19A, in the disclosure, the state in which the first die and the second die are disposed to face each other is not limited to the state in which the first die and the second die are disposed to face each other in the up-down direction, and can be optionally set. In FIGS. 19A and 19B, illustration of the upper insert 70, the lower insert 80, and the workpiece 90 is omitted for convenience of description. The structure of the die 30X in FIG. 19A is similar to the structure of the die 30 in FIG. 1 except for the arrangement state of the first die 10X and the second die 20X.

The first cam member 102 includes a sliding surface 102A inclined at about 45 degrees with respect to the horizontal plane in a lower portion, and the second cam member 104 includes a sliding surface 104A having substantially the same inclination angle as the sliding surface 102A of the first cam member 102 in an upper portion. Note that the inclination angle is not limited to 45 degrees and can be appropriately changed. The sliding surface 102A of the first cam member 102 and the sliding surface 104A of the second cam member 104 are in contact with each other.

The first cam member 102 is lowered together with the slide 60. In addition, the sliding surface 102A of the first cam member 102 and the sliding surface 104A of the second cam member 104 are smooth to each other, and as illustrated in FIG. 19B, when the first cam member 102 is lowered, the second cam member 104 moves horizontally to the right side in conjunction with each other. That is, a cam structure is formed by the first cam member 102 and the second cam member 104. By the horizontal movement of the second cam member 104, the second die 20X is pressed against the first die 10X, and the workpiece sandwiched between the first die 10X and the second die 20X is press-molded into a predetermined shape.

During the press molding, similarly to the first to third embodiments in which the first die (lower die) and the second die (upper die) are disposed to face each other in the up-down direction and the bolster 50 is used, there arises a problem that the side wall of the support device 40A on which the first die 10X is supported bends by the press load. Therefore, although not illustrated, also in the press-molding apparatus 100C, the top portion 14 of the first die 10X can bend such that the center protrudes to the right side in FIG. 19B. In addition, the top portion 24 of the second die 20X may bend such that the center thereof protrudes to the left side in FIG. 19B. However, similarly to the case of the first to third embodiments, the deflection of the top portions 14 and 24 can be suppressed by providing the stiffening members 18 and 28 in the first die 10X or the second die 20X.

The die and the press-molding apparatus according to the disclosure can also be configured by partially combining the configurations illustrated in FIGS. 1 to 19. For example, in the stiffening member of the disclosure, the root portion may have a plate shape, and the portion on the workpiece side may include one or more rod-shaped portions. The disclosure includes various embodiments and the like that are not described above, and the technical scope of the disclosure is defined only by the matters specifying the invention in the claims appropriate from the above description.

### Supplementary Note

From the present specification, the following aspects are conceptualized.

That is, a first aspect is
a die including a first die and a second die, in which at least one of the first die or the second die includes:
a bottom portion having a plate shape;
a top portion that has a plate shape and is provided apart from the bottom portion; and
a stiffening member having one end directly connected to the bottom portion and another end connected to the top portion, the stiffening member extending in an inclined manner from a connection portion with the bottom portion toward a side at which a center of the top portion is located as the stiffening member extends from the bottom portion side toward the top portion side.

A second aspect is
the die according to the first aspect, in which the stiffening member is provided only at the first die.

A third aspect is
the die according to the first aspect, in which the stiffening member is provided only at the second die.

A fourth aspect is
the die according to the first aspect, in which the stiffening member is provided at both the first die and the second die.

A fifth aspect is
the die according to any one of the first to fourth aspects, in which a pair of the stiffening members is disposed across a center of the top portion.

A sixth aspect is
the die according to any one of the first to fifth aspects, in which at least one of the first die or the second die further includes a longitudinal rib extending in parallel along a movable direction of a slide of a pressing machine, and
in which the longitudinal rib, the bottom portion, and the stiffening member form a truss structure.

A seventh aspect is
the die according to any one of the first to sixth aspects, in which the connection portion with the bottom portion of the stiffening member or a connection portion with the top portion of the stiffening member is wider than a central region of the stiffening member.

An eighth aspect is
the die according to any one of the first to seventh aspects, in which, in at least one of the first die or the second die, the stiffening member is formed integrally with the bottom portion and the top portion.

A ninth aspect is
the die according to any one of the first to seventh aspects, in which, in at least one of the first die or the second die, the stiffening member is formed separately from the bottom portion and the top portion.

A tenth aspect is
a press-molding apparatus including:
a support device;
a slide that is lowered during press molding; and
a die according to any one of the first to ninth aspects, which is disposed between the support device and the slide.

### Other Aspects

In addition, the following other aspects are conceptualized from the present specification.

That is, a first aspect is
a die including a first die and a second die, in which at least one of the first die or the second die includes:
a bottom portion having a plate shape;
a top portion that has a plate shape and is provided apart from the bottom portion; and
a stiffening member having one end directly connected to the bottom portion and another end connected to the top portion, the stiffening member extending in an inclined manner from a connection portion with the bottom portion toward a side at which a center of the top portion is located as the stiffening member extends from the bottom portion side toward the top portion side.

Another second aspect is
the die according to the another first aspect, in which the stiffening member is provided only at the first die.

Another third aspect is
the die according to the another first aspect, in which the stiffening member is provided only at the second die.

Another fourth aspect is
the die according to the another first aspect, in which the stiffening member is provided at both the first die and the second die.

Another fifth aspect is
the die according to any one of the other first to fourth aspects, in which a pair of the stiffening members is disposed across a center of the top portion.

Another sixth aspect is
the die according to any one of the other first to fifth aspects, in which at least one of the first die or the second die further includes a longitudinal rib extending in parallel along a movable direction of a slide of a pressing machine, and
in which the longitudinal rib, the bottom portion, and the stiffening member form a truss structure.

Another seventh aspect is
the die according to any one of the other first to sixth aspects, in which a connection portion with the bottom portion of the stiffening member or a connection portion with the top portion of the stiffening member is wider than a central region of the stiffening member.

Another eighth aspect is
the die according to any one of the other first to seventh aspects, in which, in at least one of the first die or the second die, the stiffening member is formed integrally with the bottom portion and the top portion.

Another ninth aspect is
the die according to any one of the other first to seventh aspects, in which, in at least one of the first die or the second die, the stiffening member is formed separately from the bottom portion and the top portion.

Another tenth aspect is
a press-molding apparatus including:
a support device;
a slide that is lowered during press molding; and
a die according to any one of the other first to ninth aspects, which is disposed between the support device and the slide.

In the other aspects described above, the following operations and effects are obtained.

According to the die and the press-molding apparatus according to the other aspects, it is possible to suppress deflection of the die on the workpiece side by directly improving the die itself relatively easily without the need to improve the configuration on the pressing machine side.

The disclosure of Japanese Patent Application Laid-Open (JP-A) No. 2020-169395 filed on Oct. 6, 2020 is incorporated herein by reference in its entirety.

In addition, all documents, patent applications, and technical standards described herein are incorporated herein by reference to the same extent as if each individual document, patent application, and technical standard were specifically and individually described to be incorporated by reference.
10, 10Z lower die (first die)
10X first die
12 bottom portion
14 top portion
16 longitudinal rib
18 stiffening member
20, 20Z upper die (second die)
20X second die
22 bottom portion
24 top portion
25 side wall
26 longitudinal rib
28 stiffening member
30, 30X die
40 bed (support device)
40A support device
42 cavity
50 bolster
60 slide
70 lower insert
80 upper insert
90 workpiece
100, 100A, 100B, 100C, 100Z press-molding apparatus
B deepest portion of bolster
C1, C2 deepest portion of top portion
D1, D2 deflection amount
E virtual position
G maximum gap
L maximum length between lower insert and upper insert
t thickness of workpiece

1. A die comprising a first die and a second die, wherein at least one of the first die or the second die comprises:
a bottom portion having a plate shape;
a top portion that has a plate shape and is provided apart from the bottom portion; and
a stiffening member having one end directly connected to the bottom portion and another end connected to the top portion, the stiffening member extending in an inclined manner from a connection portion with the bottom portion toward a side at which a center of the top portion is located as the stiffening member extends from the bottom portion side toward the top portion side.

2. The die according to claim 1, wherein the stiffening member is provided only at the first die.

3. The die according to claim 1, wherein the stiffening member is provided only at the second die.

4. The die according to claim 1, wherein the stiffening member is provided at both the first die and the second die.

5. The die according to claim 1, wherein a pair of the stiffening members is disposed across a center of the top portion.

6. The die according to claim 1, wherein:
at least one of the first die or the second die further includes a longitudinal rib extending in parallel along a movable direction of a slide of a pressing machine, and
wherein the longitudinal rib, the bottom portion, and the stiffening member form a truss structure.

7. The die according to claim 1, wherein the connection portion with the bottom portion of the stiffening member or a connection portion with the top portion of the stiffening member is wider than a central region of the stiffening member.

8. The die according to claim 1,
wherein, in at least one of the first die or the second die, the stiffening member is formed integrally with the bottom portion and the top portion.

9. The die according to claim 1, wherein, in at least one of the first die or the second die, the stiffening member is formed separately from the bottom portion and the top portion.

10. A press-molding apparatus comprising:
a support device;
a slide that is lowered during press molding; and
a die according to claim 1, which is disposed between the support device and the slide.
